(19) United States
(12) Patent Application Publication
(10) Pub. No.: US 2025/0332503 A1
(43) Pub. Date: Oct. 30, 2025

(54) Alternative Gaming Controller

(71) Applicant: Jalen Mallory, Indianapolis, IN (US)

(72) Inventor: Jalen Mallory, Indianapolis, IN (US)

(21) Appl. No.: 19/093,565

(22) Filed: May 19, 2025

Related U.S. Application Data
(60) Provisional application No. 63/632,747, filed on Apr. 11, 2024.

(51) Int. Cl. A63F 13/22; A63F 13/24; A63F 13/54

(52) U.S. Cl. CPC A63F 13/22; A63F 13/24; A63F 13/54

(57) ABSTRACT

An inclusive and accessible gaming controller designed to accommodate users with disabilities or alternative physical needs. The controller comprises a housing suitable for one-handed or two-handed operation, featuring configurable input buttons, directional controls, and tactile side switches. An integrated speaker provides localized audio output. Wireless communication capability allows pairing with external gaming systems or computers, while a rechargeable USB-C battery supports extended operation. Customizable button mapping tailors functionality to individual user needs.

### CROSS-REFERENCE TO RELATED APPLICATIONS

Provisional Application No.: [63/632,747]

Filing Date: [Apr. 11, 2024]

### STATEMENT REGARDING FEDERALLY SPONSORED RESEARCH OR DEVELOPMENT

### THE NAMES OF THE PARTIES TO A JOINT RESEARCH AGREEMENT

NOT APPLICABLE

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

NOT APPLICABLE

### STATEMENT REGARDING PRIOR DISCLOSURES BY THE INVENTOR OR A JOINT INVENTOR

No prior public disclosure by the inventor or a joint inventor.

### BACKGROUND OF THE INVENTION:

### (1) Field of the Invention

The present invention relates generally to video game controllers, and more specifically, to an inclusive and accessible gaming controller designed for individuals with physical disabilities or alternative ergonomic needs.

### (2) Description of Related Art Including Information Disclosed Under 37 CFR 1.97 and 1.98

US-2009/0054146 A1 (Epstein et al)—A modular, single-handed video game controller system designed for users with limited mobility. The controller comprises interchangeable modules that replicate standard gaming functions, allowing for customizable configurations.
US-2010/0137054 A1 (Yukinori INAMURA)—A game controller featuring a touch-sensitive input surface that detects user gestures and pressure. The design aims to enhance user interaction by providing intuitive control mechanisms beyond traditional buttons and joysticks.
US-2022/0370894 A1 (John Elias Fahmie)—A system for remote control of devices using a combination of voice commands and gesture recognition. The technology focuses on improving accessibility and user experience in controlling various electronic devices.
US-2021/0268371 A1 (John Elias Fahmie)—An adaptive user interface system that personalizes device controls based on user behaviour and preferences. The system learns from user interactions to optimize control layouts and functionalities.
US-2007/0173304 A1 (Mcilvain et al)—A wearable input device that translates physical movements into control signals for electronic systems. The device is designed to provide hands-free operation, particularly beneficial in virtual reality and gaming applications.
U.S. Pat. No. 5,394,168 (Smith, III et al)—An ergonomic hand-held controller with strategically placed buttons and grips to reduce user fatigue. The design emphasizes comfort and prolonged usability during extended periods of operation.
U.S. Pat. No. 11,369,867 B2 (Hiffer et al)—Presents a multi-modal input device that integrates touch, motion, and voice controls. The device aims to provide a seamless user experience by allowing multiple forms of input for controlling electronic systems.
U.S. Pat. No. 10,987,577 B2 (Paul M Dixon)—A hand-held game controller with cooling features includes a housing with at least one hand grip extending therefrom, which forms a hand grip cavity.
U.S. Pat. No. 8,313,379 B2 (Ikeda et al)—a video game system featuring wireless modular handheld controllers. The controllers can be configured with various modules to suit different gaming applications, enhancing versatility and user customization.

### BRIEF SUMMARY OF THE INVENTION

The Alternative Gaming Controller is an inclusive gaming controller designed for users with disabilities or alternative needs. It features customizable buttons, one-handed usability, wireless communication, and a built-in speaker for an accessible and immersive gaming experience.

### BRIEF DESCRIPTION OF THE SEVERAL VIEWS OF THE DRAWING(S)

FIG. 1: Alternative Gaming Controller (Exploded View)

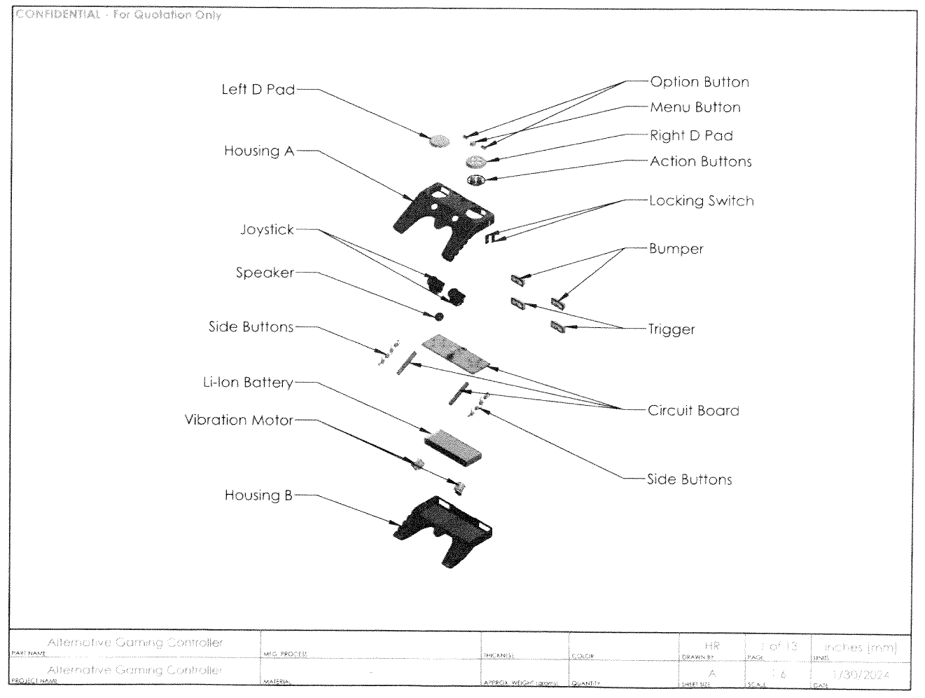

FIG. 2: Alternative Gaming Controller (Completely Assembled)

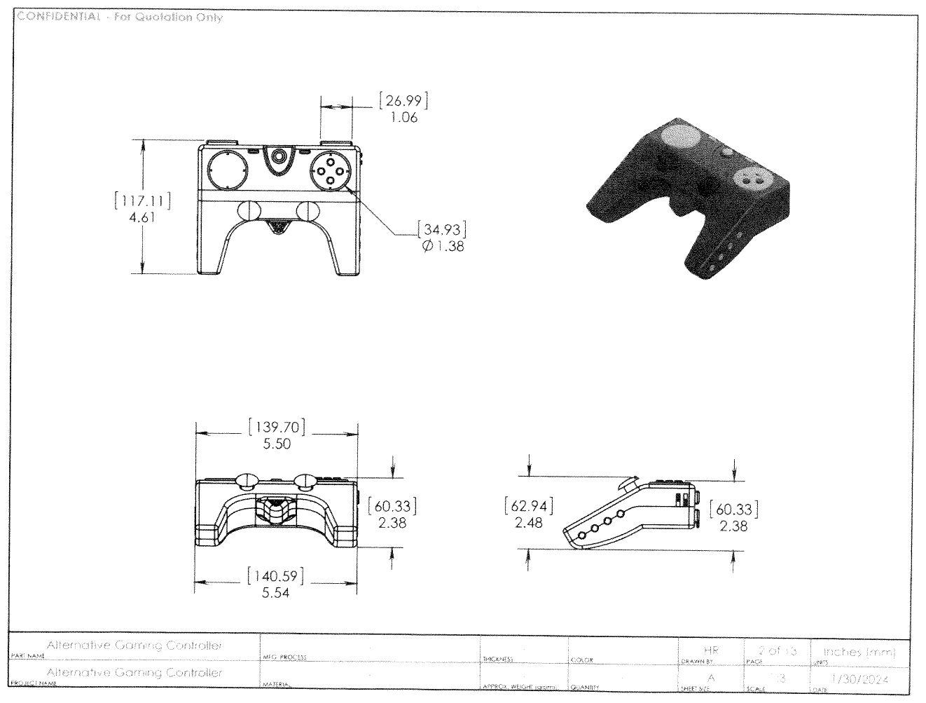

FIG. 3: Housing A (Front Plate)

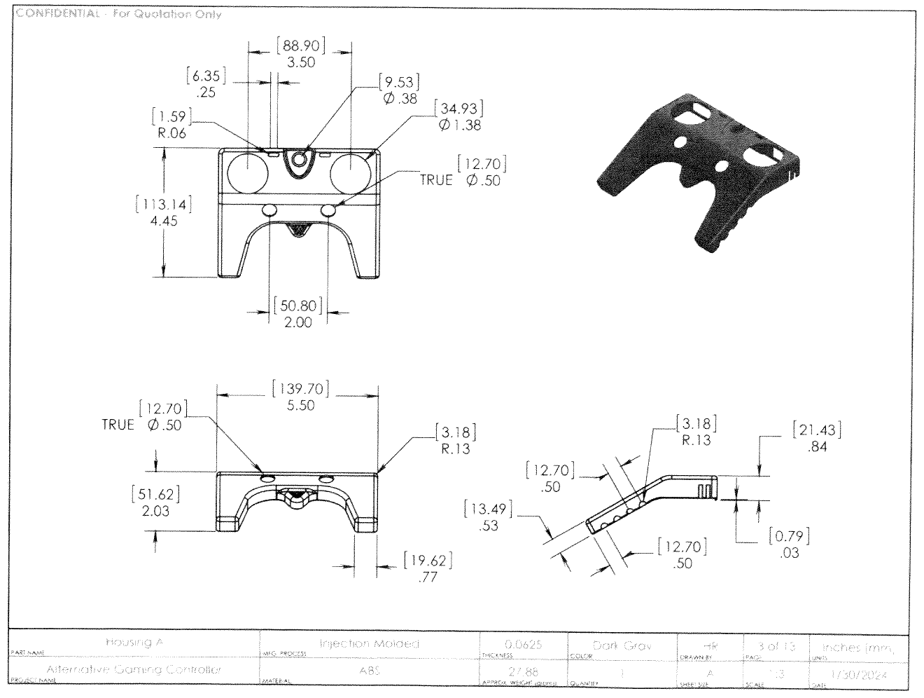

FIG. 4: Housing B (Back Plate)

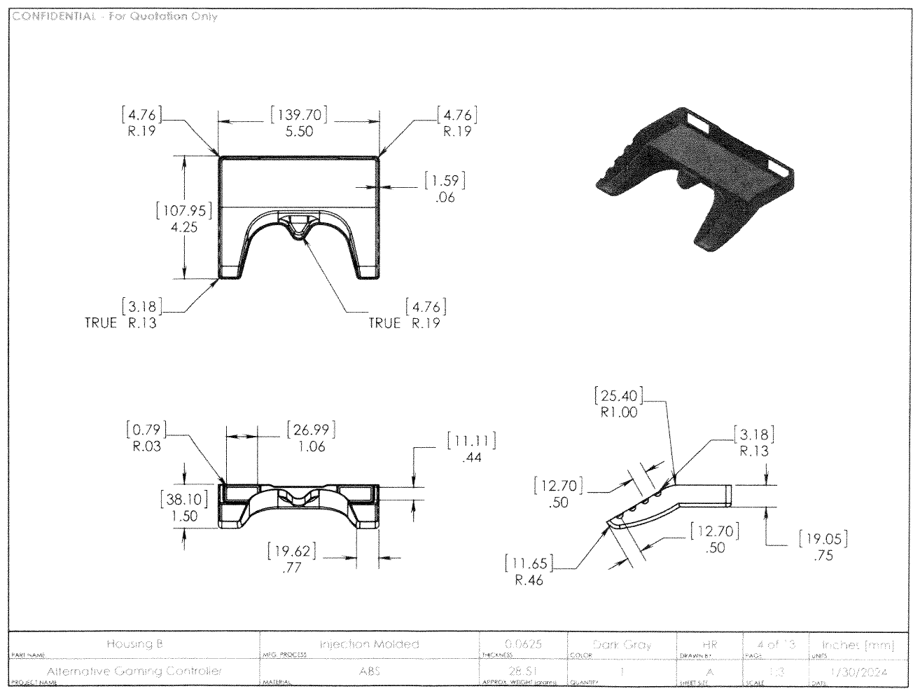

FIG. 5: Menu Button

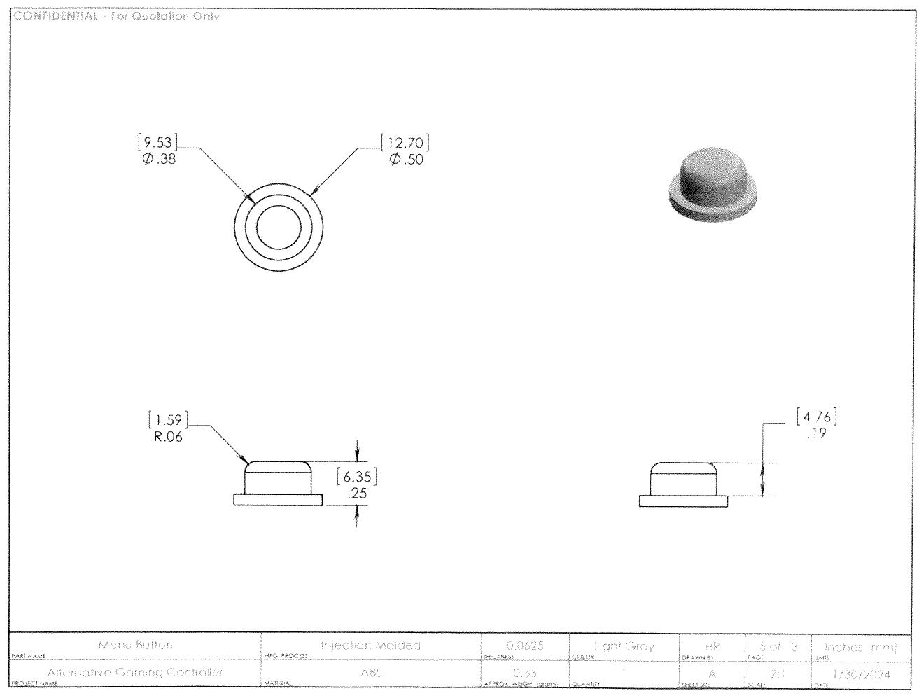

FIG. 6: Option Button

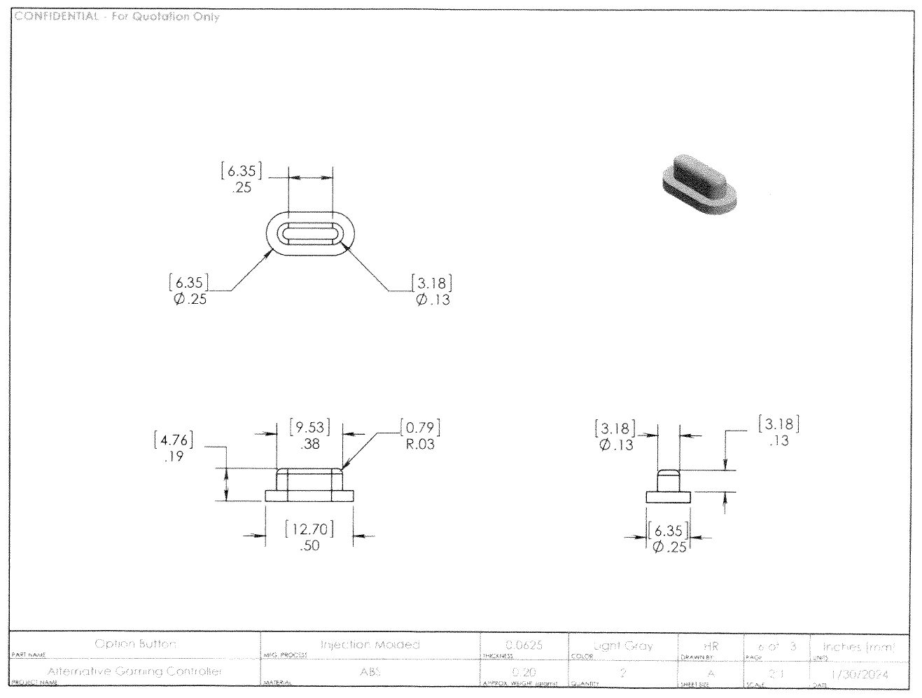

FIG. 7: Left Directional Pad

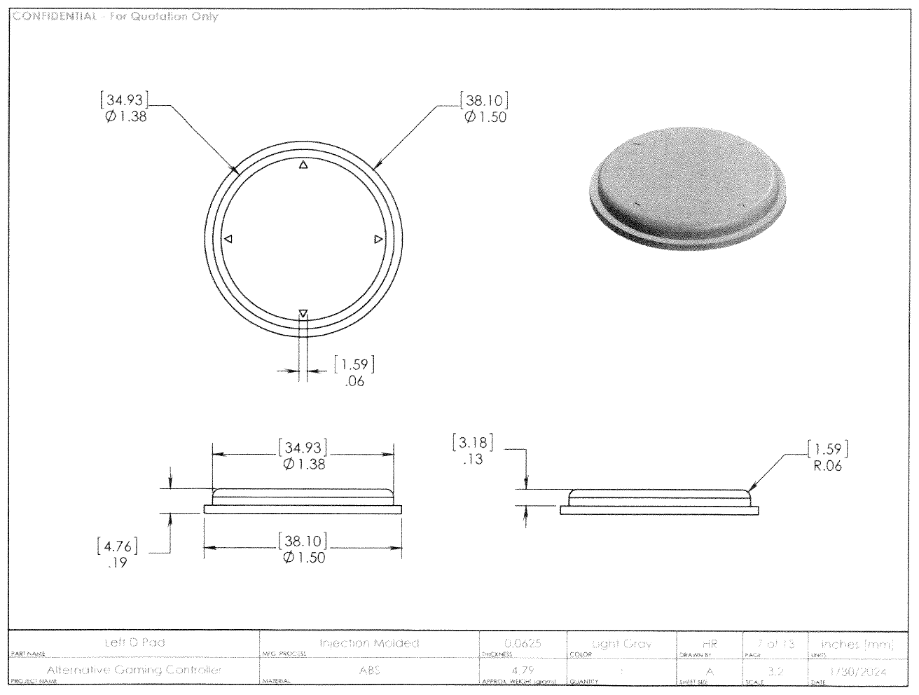

FIG. 8: Right Directional Pad (Has openings for Action Buttons)

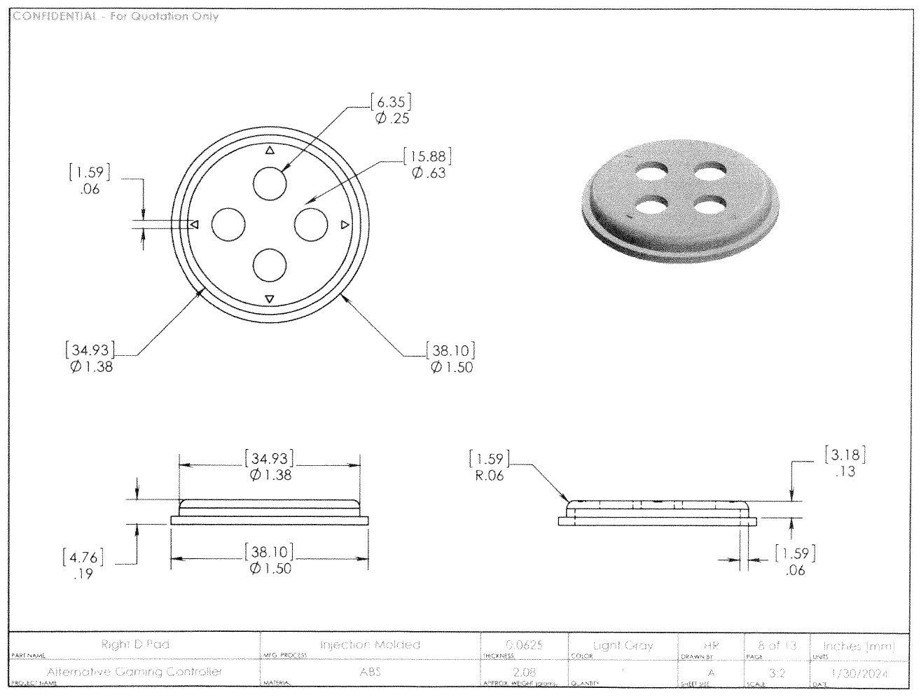

FIG. 9: Action Buttons (Fit inside Right Directional Pad)

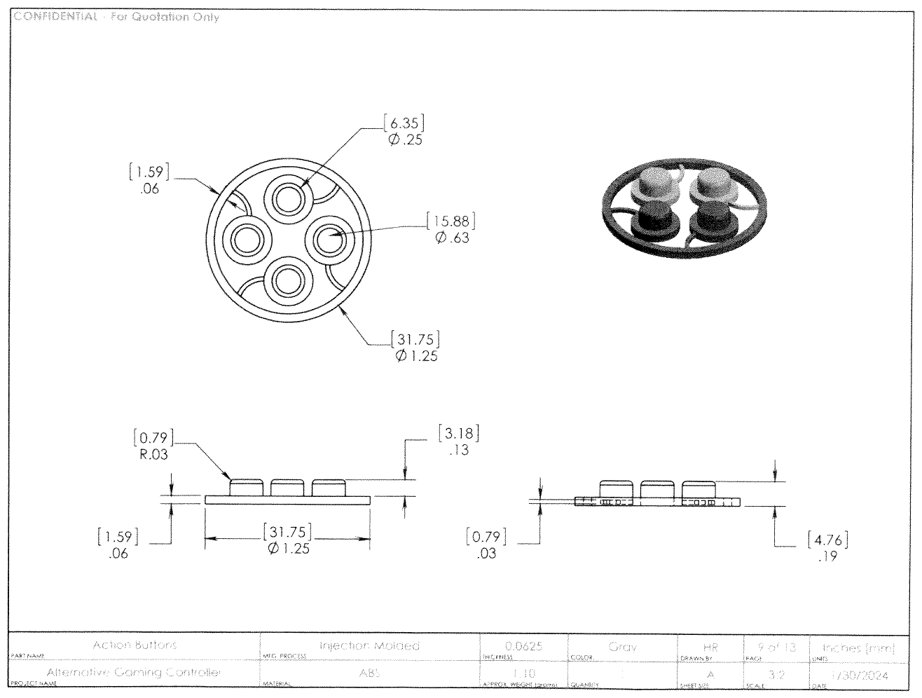

FIG. 10: Side Button (Go on both sides when plates are put together)

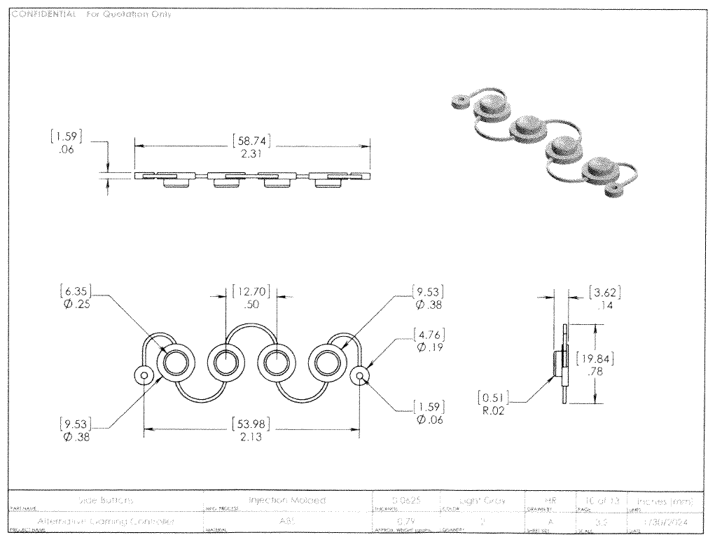

FIG. 11: Bumper

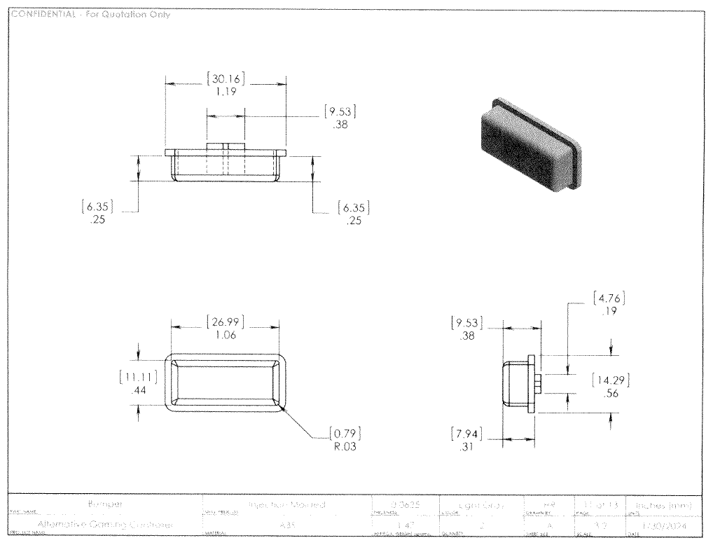

FIG. 12: Trigger

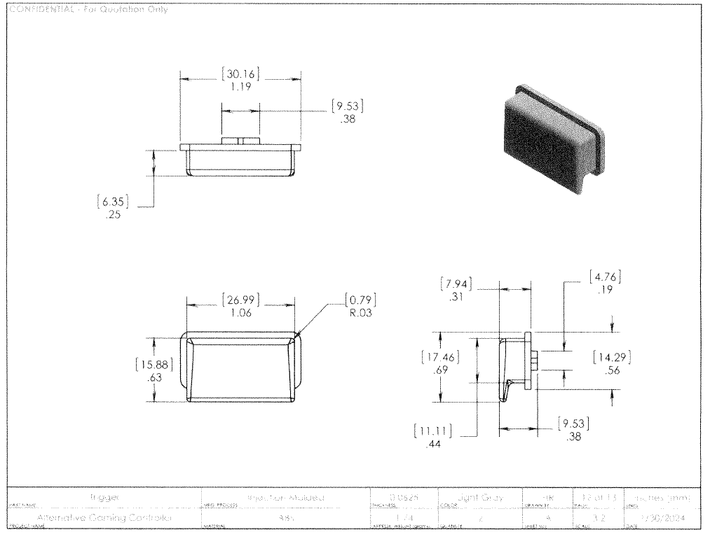

FIG. 13: Locking Switch (Used to alternate from Right Directional Pad to Action Buttons and back.

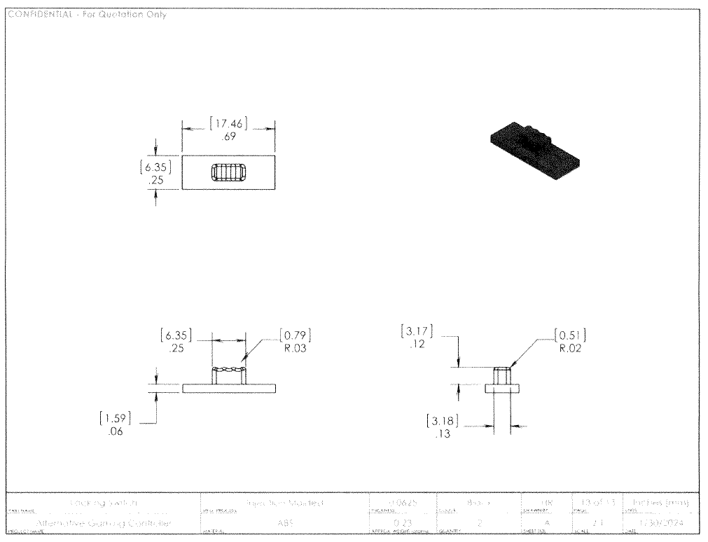

### DETAILED DESCRIPTION OF THE INVENTION

The Alternative Gaming Controller is a newly designed gaming controller focused on inclusivity and accessibility. Traditional controllers often exclude players with disabilities due to their complexity or lack of customization. The Controller addresses this gap by offering a versatile device that can be used with either one or two hands. It includes adjustable side switches, customizable d-pad and buttons, a centrally placed speaker for enhanced audio proximity, and compatibility with PC and other gaming consoles.

The controller also features modern tech integration such as wireless communication and a USB-C rechargeable battery, making it both flexible and convenient. Users can easily pair it with their preferred gaming systems and remap the buttons to suit their preferences or needs. With the Alternative Gaming Controller, gaming becomes more accessible, empowering a wider audience to enjoy video games with comfort and ease

1: An inclusive gaming controller comprising:
a housing configured for one-handed or two-handed operation;
a plurality of user-configurable input buttons and directional controls located on multiple sides of the housing;
a speaker integrated into the central region of the housing for localized audio output;
a wireless communication module for pairing with external gaming systems; and
a rechargeable power source configured to be charged via a USB-C connection;
wherein the controller is adapted to allow customizable input mapping for use by individuals with varying physical abilities.

2: The inclusive gaming controller of claim 1, further comprising tactile switches positioned on side surfaces of the housing for alternative directional input.

3: The inclusive gaming controller of claim 1, wherein the user-configurable input mapping is performed through software that allows button assignments to be altered based on user preference or disability needs.
